(19) United States
(12) Patent Application Publication
(10) Pub. No.: US 2021/0055248 A1
(43) Pub. Date: Feb. 25, 2021

(54) REFERENCE ELECTRODES FOR MOLTEN SALT SYSTEMS, AND RELATED METHODS AND ELECTROCHEMICAL SYSTEMS

(71) Applicant: Battelle Energy Alliance, LLC, Idaho Falls, ID (US)

(72) Inventors: Prabhat K. Tripathy, Idaho Falls, ID (US); Michael R. Shaltry, Idaho Falls, ID (US)

(21) Appl. No.: 16/947,863

(22) Filed: Aug. 20, 2020

Related U.S. Application Data
(60) Provisional application No. 62/889,084, filed on Aug. 20, 2019.

(51) Int. Cl. G01N 27/30; G01N 27/411

(52) U.S. Cl. CPC G01N 27/301; G01N 27/4117

(57) ABSTRACT

Various embodiments of the disclosure provide reference electrodes for use in electrochemical systems (e.g., electrochemical cells) that use molten salt media as the electrolyte of choice. The reference electrodes include a metal core with an outer, solid layer of the metal's oxide, silicide, or carbide. The oxide, silicide, or carbide outer layer may be formed uniformly and with sufficient durability to withstand exposure to molten salt material. The outer layer may be formed by processes configured to form (e.g., grow) the oxide, silicide, or carbide layer directly on the outer surface of the metal core with uniformity of the layer's composition and thickness all along the outer surface of the metal core. Related electrochemical systems are also disclosed.

### CROSS-REFERENCE TO RELATED APPLICATION

This application claims the benefit, under 35 U.S.C. § 119(e), of U.S. Provisional Patent Application Ser. No. 62/889,084, filed Aug. 20, 2019, the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

The disclosure, in various embodiments, relates generally to electrochemical systems comprising molten salt electrolytes and to reference electrodes for molten salt systems. More particularly, this disclosure relates to reference electrodes for use in molten salt electrochemical systems, to methods of forming such reference electrodes, and to related electrochemical systems.

### BACKGROUND

Since the 1950s, molten salts have been extensively deployed in a number of diverse industries and technological areas, including nuclear energy, solar (e.g., solar energy), battery, fuel cell, catalysis, electroplating, coal gasification, manufacture of advanced/engineering materials, materials recycling, extraction, and refining processing (e.g., refining and chemical processing of refractory metals) industries. Within these industries, as well as others, molten salts (e.g., fused salts) possess excellent thermal conductivity and so are often used as energy-storage or energy-conversion media, such as heat-transfer media (e.g., coolants) in extremely-high-temperature (e.g., nuclear energy) systems. Therefore, molten salts and systems including such molten salts are of interest to various industries and to scientific communities.

Electrochemistry presents an important opportunity to study molten salts, such as to measure the properties of such molten salt materials and of molten salt systems. In electrochemical systems (e.g., electrochemical cells), electrical energy may be generated from chemical reactions between electrodes and a solvent (e.g., electrolyte solution, which may be otherwise referred to herein as a “bulk electrolyte”), e.g., in electrochemical systems known as “voltaic cells” or otherwise known as “galvanic cells.” In other electrochemical systems, electrical energy may be used to cause chemical reactions (e.g., between electrodes and a solvent), e.g., in electrochemical systems known as electrolytic cells. Using appropriately-designed and configured electrochemical systems, various electrochemical measurements can be taken to evaluate the properties of materials within the system, such as to evaluate and/or control the properties of materials (e.g., the solvent (e.g., electrolyte solution)) used in the system. For example, and without limitation, evaluated and/or controlled properties may include thermodynamic data of the salt systems, estimation of corrosion phenomena, concentration of electroactive species, process control, and/or complex species formation in a given molten salt system.

Fundamental electrochemical measurements frequently use either a two-electrode or a three-electrode configuration. While a two-electrode configuration may be conducive for use in a relatively simple electrochemical system (e.g., a system containing one or two electroactive species), a three-electrode configuration may be conducive for taking measurements in multicomponent systems containing multiple current-carrying species. For example, a three-electrode setup may be used to accurately determine the electrode potentials of both solutes and solvents of a given solution. One of the three electrodes, the “reference electrode,” can play an important role in determining electrode potential values fairly accurately. That is, measurement accuracy in multicomponent systems may often, to a large extent, depend on properties of the reference electrode. An ideal reference electrode generally combines several properties: no chemical interaction with the electrolyte of the system so that a passive layer and/or deposits will not form on the electrode's surface; good chemical and mechanical stability at the operation temperature of the system; and good reproducibility and reusability. For example, it may be desirable for the potential of the reference electrode to remain substantially unchanged during an entire duration of a given test run or measurement cycle.

With regard to molten salt media, electrochemical systems—and the electrochemical measurements that can be taken by such systems—can use molten salt media as a solvent (e.g., electrolyte solution) in association with electrodes of known or predictable properties to derive fundamental electrochemical data about the solvent (e.g., the molten salt media), as well as to obtain other useful information about the molten salt media. For example, an electrochemical measurement of the equilibrium cell potential of a galvanic cell using molten salt media as a solvent (e.g., electrolyte) is a means to directly determine the thermodynamic properties of the molten salt media. As another example, electrode polarization measurements are useful for determining corrosion phenomena. Electroanalytical techniques are also useful for monitoring concentrations of analytes (i.e., chemical species that are being studied) and for controlling electrochemical processes. Transient electrochemical techniques—e.g., chronopotentiometry, polarography, square wave voltammetry (SWV), electrochemical impedance spectroscopy (EIS), etc.—may be useful to investigate complex species formation, particularly in fluoride-based molten salt media.

Though analyzing molten salt media using electrochemistry techniques is of interest, the corrosiveness, the sensitivities (e.g., moisture-sensitivity, oxygen-sensitivity), and the high melt temperatures of many such molten salt media present challenges for designing electrochemical systems, and the components thereof, for accurate evaluations of molten salt media. The success of such electrochemical systems and the electrochemical techniques used therewith depends, often to a large extent, upon having and using a reference electrode that is reliable and stable when used within molten salt media.

Conventional, low-temperature, aqueous (i.e., water-based) electrochemical systems generally do not face the same challenges as those that are molten-salt-based. Many different types of reference electrodes have been developed for such aqueous electrochemical systems. These fixed, standard reference electrodes for aqueous systems include, e.g., hydrogen electrodes, saturated calomel electrodes (SCE), copper-copper(II) sulfate (Cu/CuSO₄) electrodes (e.g., a plastic tube containing a rod of copper and a saturated liquid solution of copper sulfate), silver chloride electrodes (Ag/AgCl) (e.g., a plastic tube containing a wire of silver thinly coated with a silver chloride), mercury-mercurous sulfate (Hg/Hg₂SO₄) electrodes, or the like. These types of reference electrodes are generally widely effective in aqueous electrochemical systems.

With molten salt electrochemical systems, on the other hand, the solvents (e.g., electrolytes) span a wide variety. For example, in some systems, the molten salt electrolytes may be low- or room-temperature melts (e.g., 1-butylpyridinium chloride-aluminum trichloride), while in other systems, the molten salt electrolytes may be very-high-temperature melts (e.g., fused fluoride salts). Accordingly, some ionic melts may have melting temperatures below 0° C. while other molten salt systems may use salts with melting points of above 1000° C. Therefore, unlike reference electrodes for aqueous electrochemical measurements, reference electrodes for molten salt electrochemical systems are often “custom-made” (e.g., custom designed and custom fabricated) so that the reference electrode is tailored for the particular molten salt solvent (e.g., molten salt electrolyte) composition. Thus, a great variety of reference electrodes are currently used in molten salt electrochemical systems because of the availability of a diverse range of the molten salt media/electrolytes.

Molten salts tend to be quite corrosive because of high-temperature operations and high elevated-temperature reactivity. As a result, the design of a reference electrode is often influenced by the corrosiveness of the molten salts. Thus, molten salt system reference electrode design and fabrication presents challenges, particularly as to the materials from which the reference electrode is constructed.

Efforts have been made to design effective molten salt system reference electrodes. Such reference electrodes have been classified on the basis of their electrochemical working principle or their method of application. These classifications include electrodes of the first kind (e.g., Ag/Ag⁺), second kind (e.g., PtO/O²⁻), and third kind (e.g., Pd/PdO). Categorized differently, reference electrodes, useful in molten salt media, include two types: true and pseudo (or otherwise referred to as “quasi”) reference electrodes. Some such reference electrodes may include: a chemically inert metal (such as precious and/or platinum group metals), Cl⁻/Cl₂, Ag/AgCl, graphite, or M/MₓO_{y} (e.g., Ni/NiO). Regardless of how the reference electrodes for molten salt media are categorized or classified, for each kind (e.g., type) of these reference electrodes, emphasis tends to be laid on electrode characteristics, construction details, and operating procedures.

Such reference electrodes may be useful in systems with seven types of molten salt media: halides, chloroaluminates, cryolites, nitrates, carbonates, sulfates, and hydroxides. In systems that include a mix of molten salt media (i.e., a “mixed melt”) (e.g., chloride-fluoride molten salts), reference electrodes configured for either chloride melts or fluoride melts may be used, depending on the composition. Nonetheless, there have been no definite rules developed for how best to tailor the design of a reference electrode to a particular molten salt to be used therewith. Experimentation continues to be necessary to determine the applicability of any particular reference electrode design in a molten salt media, particularly in a mixed melt system.

Some of the reference electrodes useful in various chloride molten salts are tabulated, below, in Table I:

TABLE I
Reference Electrodes Useful in Chloride Melts

| Reference Electrode | Operating Temp. Range (° C.) |
|---|---|
| Cl⁻/Cl₂ | 25-900 |
| Ni/Ni₃S₂ | 300-500 |
| Ag/Ag⁺ | 25-1100 |
| Pt/Pt²⁺ | 350-500 |
| Li—Al/Li⁺ | 300-550 |

Some of the miscellaneous reference electrodes that have been used in various chloride melts include, e.g., (i) Pb/Pb²⁺ reference electrodes for thermodynamic measurements (ii) Cu/Cu₂O/O²⁻, Pt/PtO/O²⁻, Pd/PdO/O²⁻, and/or Bi/BiOCl/O²⁻ reference electrodes. Regarding the latter grouping, because of relatively high stability of these metal oxides, the applicability of the reference electrodes to the measurement of oxide activity is limited to solutions containing O²⁻ in concentrations comparable with or greater than those contributed by dissolution of the metal oxide being studied.

Quasi-reference electrodes are yet another class of reference electrodes that may be used in molten salt electrochemical systems. The application of quasi-reference electrodes is based on the principle that some metals (e.g., glassy carbon, Ag, Pt, Au, Ni, etc.) when dipped directly into the melt (e.g., the molten salt media) can act as an electrode having a potential that is maintained by some species of the electrolyte (e.g., the molten salt media) in an often unknown electrode process. The potential of such metal quasi-reference electrodes is stable as long as the possibly-unknown electrode process is invariant. If the process is stable (e.g., invariant) during a required length of the experiment, as has been observed in several cases, the metal may function effectively as a reference electrode. It is hypothesized that metal ions, formed in the melt (e.g., the molten salt media) by corrosion of the metal of the quasi-reference electrode, may strongly adsorb onto the electrode surface and give rise to a more or less defined adsorption potential. However, quasi-reference electrodes may not be very reliable because they are often quite sensitive to small changes in composition or impurity content of the electrolyte (e.g., the molten salt media). Although this is a general observation, several quasi-reference electrodes have been observed to behave like true reference electrodes for a reasonable length of time. For example, glassy carbon may be used as a true reference electrode in pure eutectic bromide-based molten salt media (e.g., LiBr—KBr, LiBr—KBr—CsBr) in the temperature range of 200° C. to 450° C. A platinum (Pt) quasi-reference electrode may be stable in fluoride melts (e.g., fluoride-based molten salt media) even over a period of months.

From among the various types of potential reference electrodes, Ag/AgCl is a popular type of reference electrode, being used in different configurations with the Ag/AgCl being contained in an ion conducting membrane (e.g., a tube of PYREX®, quartz, porcelain, mullite membrane, graphite-protected silica, boron nitride tube, and/or porous alumina). On the other hand, M/MₓO_{y}-type reference electrodes are routinely used in the nuclear industry for processing and/or treating spent fuel. For example, a reference electrode (e.g., an Ni/NiO reference electrode) may be used to electrochemically reduce used uranium oxide to uranium metal and/or to produce rare-earth elements by electrodeposition techniques. Moreover, Ni/NiO reference electrodes have been used extensively in both fluoride melts and chloride melts. A conventional Ni/NiO reference electrode, if intended for use in a chloride media (e.g., a chloride-based molten salt media), may be fabricated by keeping a nickel wire, with a 1 mm diameter, in close contact with a few grams (e.g., about 1 g) of high-purity NiO. A conventional Ni/NiO reference electrode, if intended for use in a fluoride media (e.g., a fluoride-based molten salt media), may be fabricated by immersing a nickel wire in molten LiF—BeF₂ that has been saturated with NiO and BeO. The concentration of Ni²⁺ is held constant because of the low solubility product of NiO and the presence of common ion (O²⁻), which, in turn, is held constant by the presence of the saturating mixture of NiO/BeO. In general, Ni/NiO reference electrodes may be usable in any fluoride-based molten salt media that is not too basic, provided that the fluoride-based molten salt media contains a cation of an oxide with low solubility. However, the seeming versatility and performance reliability of Ni/NiO reference electrodes does have limits. For example, improper fabrication processes may form reference electrodes that do not provide accurate measurements. Also, Ni/NiO reference electrodes have shown signs of random fluctuations in measured voltages across a wide range of measurements, particularly when used in long-term measurements. One of the shortcomings these electrodes may exhibit may be due to the absence of an intimate contact between the metal (e.g., Ni) and its oxide (e.g., NiO) or due to an insufficient surface area of the metal (e.g., Ni) in the oxide matrix (e.g., NiO) or due to the dissolution of NiO in the electrolyte. Therefore, designing and fabricating effective reference electrodes, including effective M/MₓO_{y}-type reference electrodes, for molten salt media continues to present challenges.

### BRIEF SUMMARY

Various embodiments of the disclosure provide reference electrodes for molten salt electrochemical systems, wherein the reference electrodes are solid structures comprising a metal core and a corresponding metal-based compound (e.g. metal oxide, metal silicide, or metal carbide) outer layer. The direct, physical contact between the metal core and its corresponding metal-based compound (e.g., an oxide of the metal, a silicide of the metal, or a carbide of the metal) in the outer layer provides sufficient contact for measuring electrical potentials. The outer metal-based compound layer may be formed uniformly over the metal core's surface and with sufficient durability to withstand exposure to molten salt media.

In some embodiments, disclosed is a reference electrode for a molten salt system. The reference electrode comprises a metal core and a metal-based compound layer along an outer surface of the metal core. The metal-based compound layer comprises an oxide, a silicide, or a carbide of the metal of the metal core. The metal core and the metal-based compound layer are each solid.

In some embodiments, disclosed is a method for fabricating a reference electrode for molten salt systems. The method comprises growing a metal-based compound on an outer surface of a metal structure to form an oxide, silicide, or carbide layer uniformly coating the outer surface.

In these or other embodiments, disclosed is an electrochemical system. The electrochemical system comprises an electrolyte comprising a molten salt media. The electrochemical system also comprises a reference electrode comprising a metal-oxide layer, a metal-silicide layer, or a metal-carbide layer on a metal core.

### BRIEF DESCRIPTION OF THE DRAWINGS

FIG. 1 is a top and front, perspective, schematic illustration of a reference electrode, in accordance with embodiments of the disclosure, wherein the reference electrode has a rod-like shape.

FIG. 2 is a top plan, cross-sectional, schematic illustration of a reference electrode—such as the reference electrode of FIG. 1—in accordance with embodiments of the disclosure, wherein the view of FIG. 2 is taken along section line A-A of FIG. 1.

FIG. 3 is a top, front, and right-side, isometric, schematic illustration of a reference electrode, in accordance with embodiments of the disclosure, wherein the reference electrode has a plate-like shape.

FIG. 4 is a top plan, cross-sectional, schematic illustration of a reference electrode—such as the reference electrode of FIG. 3—in accordance with embodiments of the disclosure, wherein the view of FIG. 4 is taken along section line B-B of FIG. 3.

FIG. 5 is a right-side, elevational, schematic illustration of a reference electrode—such as the reference electrode of FIG. 1 or of FIG. 3—in accordance with embodiments of the disclosure, wherein the view of FIG. 2 and/or of FIG. 4 may be taken along section line B-B of FIG. 5.

FIG. 6 is a top, front, and right-side, isometric illustration of a reference electrode, in accordance with embodiments of the disclosure, wherein the reference electrode has a rod-like shape in an upper portion and a plate-like shape in a lower portion, such that the view of FIG. 2 may be taken along section line A-A of FIG. 6 and the view of FIG. 4 may be taken along section line B-B of FIG. 6.

FIG. 7 is a right-side, elevational, schematic illustration of a reference electrode—such as the reference electrode of FIG. 6—in accordance with embodiments of the disclosure, such that the view of FIG. 2 may be taken along section line A-A of FIG. 7 and the view of FIG. 4 may be taken along section line B-B of FIG. 7.

FIG. 8 is a simplified, elevational, schematic illustration of an electrochemical system, in accordance with embodiments of the disclosure, in which a reference electrode—such as any of the reference electrodes of FIG. 1 through FIG. 17—may be used.

FIG. 9A through FIG. 13 relate to Examples, discussed below, in accordance with embodiments of the disclosure, wherein:

FIG. 9A is a photograph showing an un-oxidized (as-received) 1 mm nickel wire.

FIG. 9B is a photograph showing the wire of FIG. 9A with a change in the coloration of the surface nickel after thermal oxidation (in static air) at 600° C. for a total duration of eight hours and subsequently annealing the partially oxidized wire in argon at 700° C. for about six hours.

FIG. 10 is a chart showing the measurement—using the thermally oxidized and annealed nickel wire of FIG. 9B—of the open-circuit potential (OCP) for different durations and/or cycles in a eutectic LiCl—KCl electrolyte.

FIG. 11 is a chart showing cyclic voltammetry measurements—using the thermally oxidized and annealed nickel wire of FIG. 9B, post the OCP measurements for FIG. 10—in the eutectic LiCl—KCl melt (e.g., electrolyte) containing 2 wt. % YCl₃ and 1 wt. % ScCl₃ at a temperature (of the LiCl—KCl melt) of 500° C.

FIG. 12A is a photograph of a titanium wire anodized, at 9.0V, to have a surface TiO₂ layer.

FIG. 12B is a photograph of a titanium wire anodized, at 108V, to have a surface TiO₂ layer.

FIG. 13 is a chart showing measurements collected using the anodized titanium wire of FIG. 12B.

### DETAILED DESCRIPTION

Disclosed are reference electrodes, and methods for fabricating such reference electrodes, configured for use with molten salt systems, e.g., molten salt electrochemical systems. A reference electrode, according to embodiments of the disclosure, comprises a metal core with an outer layer of the metal's oxide, silicide, or carbide (collectively or individually referred to herein as a “metal-based compound”). By forming the reference electrode according to embodiments of the disclosure, the metal-based compound layer forms uniformly (e.g., with uniform thickness) along the outer surface of the metal core and forms with sufficient tenacity to survive contact with harsh, molten salt media.

As used herein, the term “molten salt” refers to molten media, which may or may not be wholly ionic or derived from simple salts.

As used herein, the term “molten salt systems” refers to electrochemical systems utilizing a molten salt electrolyte (e.g., a molten salt bulk electrolyte).

As used herein, the term “metal core” refers to a monolithic structure (e.g., a rod, a wire, or the like) comprising, consisting essentially of, or consisting of at least one metal.

As used herein, the term “solid,” when referring to a material or structure, refers to such referenced material or structure being in a firm and stable—or substantially firm and stable—phase, as opposed to being in a liquid or other flowable phase. A “solid” material or structure may also be nonporous.

As discussed above, conventional reference electrodes intended for use with molten salt systems—such as conventionally-structured and conventionally-fabricated Ni/NiO reference electrodes—have shown signs of random fluctuations in measured voltages across a wide range of measurements, particularly when used in long-term measurements. It is contemplated that these problems may arise because of the way the conventional reference electrode is fabricated. That is, a conventional Ni/NiO reference electrode may be fabricated by disposing a bare (e.g., uncoated nickel wire) in its oxide (e.g., nickel-oxide), which oxide may be in finely powdered form (e.g., 1 μm to 10 μm particle size). In other words, a conventional Ni/NiO reference electrode—like many other conventional reference electrodes—is fabricated as a ceramic tube that contains, therein, a solid structure (e.g., a wire) at least partially immersed within a “reference solution” (e.g., a “reference electrolyte”), such as the powdered NiO, which reference solution contains ions, such as oxide ions. However, in reference electrodes fabricated in this manner, that may be insufficient surface area contact, between the metal and its oxide (e.g., oxide ions), to accurately measure electric potentials.

Disclosed herein are new methods to fabricate reference electrodes configured for use within molten salt systems. The reference electrodes and methods disclosed herein take into consideration the metal-based-compound-formation ability (e.g., the oxide-formation ability, the silicide-formation ability, or the carbide-formation ability) of the metals of the reference electrodes and the tenacity of adherence of the metal-based compound (e.g., the oxides, the silicides, or the carbides) to the surface of the metal(s). The disclosed reference electrodes have an improved design and process due, at least in part, to the avoidance of the physical contact between the metal (e.g., the “M” of the “M/MₓO_{y}”) and the MₓO_{y}. Instead, an intimate surface metal-based compound (e.g., oxide, silicide, or carbide) layer is provided. The metal-based compound layer may function as the ion conductive medium of the reference electrode. So, by embodiments disclosed herein, at least two things are enabled. First, the finished reference electrode need not include an ionic liquid or powder solution (e.g., liquid or powdered reference solution) immersing the metal core. Instead, the metal-based compound (e.g., oxide, silicide, or carbide) layer is formed directly on the metal core, and the reference electrode is formed as a monolithic structure with its external surface provided by a uniform metal-based compound (e.g., oxide, silicide, or carbide) layer. So, the conventional immerse-in-reference-solution (e.g., metal immersed in reference electrolyte of liquid or powder form) technique for fabricating reference electrodes, which may limit the establishment of good physical contact between the metal of the metal core and its oxide, may be avoided. Second, the outer, metal-based compound (e.g., oxide, silicide, or carbide) layer may be formed by methods that not only provide a uniform contact between the metal-based compound and its underlying metal of the metal core (separated, perhaps, by only a relatively thin interface), but that also form the metal-based compound layer to be in sufficiently-strong attachment to the metal core (e.g., the metal wire) so that the metal-based compound layer can resist the attack of a molten salt media. For example, a tenacious MₓO_{y} layer (e.g., a metal-oxide layer) may be formed on the metal (M), e.g., by an anodization process, prior to the deployment of the M/MₓO_{y} reference electrode in a molten salt electrochemical cell. As another example, a tenacious MₓC_{y} layer (e.g., a metal carbide layer) may be formed on the metal (M), e.g., by forming an MₓO_{y} layer and then heating the structure with graphite powder in the presence of hydrogen or method followed by carburization. As still another example, a tenacious MₓSi_{y} layer (e.g., a metal silicide layer) may be formed on the metal (M), e.g., by polishing the metal with silicon carbide paper, cleaning in alcohol, ultrasonic cleaning and drying, burying in a pack mixture that includes silicon, and heating.

The metal (“M”), of the metal/metal-oxide (“M/MₓO_{y}”) reference electrodes disclosed herein, may comprise, consist essentially of, or consist of one or more of nickel, aluminum, tin, titanium, tungsten, hafnium, zirconium, niobium, iridium, platinum, ruthenium, palladium, rhenium, scandium, and/or calcium. Such reference electrodes may exhibit good performance characteristics, such as no significant drift in measured electric potentials. In contrast, conventional reference electrodes may exhibit significant drift.

The metal (“M”), of the metal/metal-carbide (“M/MₓC_{y}”) reference electrodes disclosed herein, may comprise, consist essentially of, or consist of one or more transition-group metal(s) and/or one or more platinum-group metal(s).

The metal (“M”), of the metal/metal-silicide (“M/MₓSi_{y}”) reference electrodes disclosed herein, may comprise, consist essentially of, or consist of one or more transition-group metal(s) and/or one or more platinum-group metal(s).

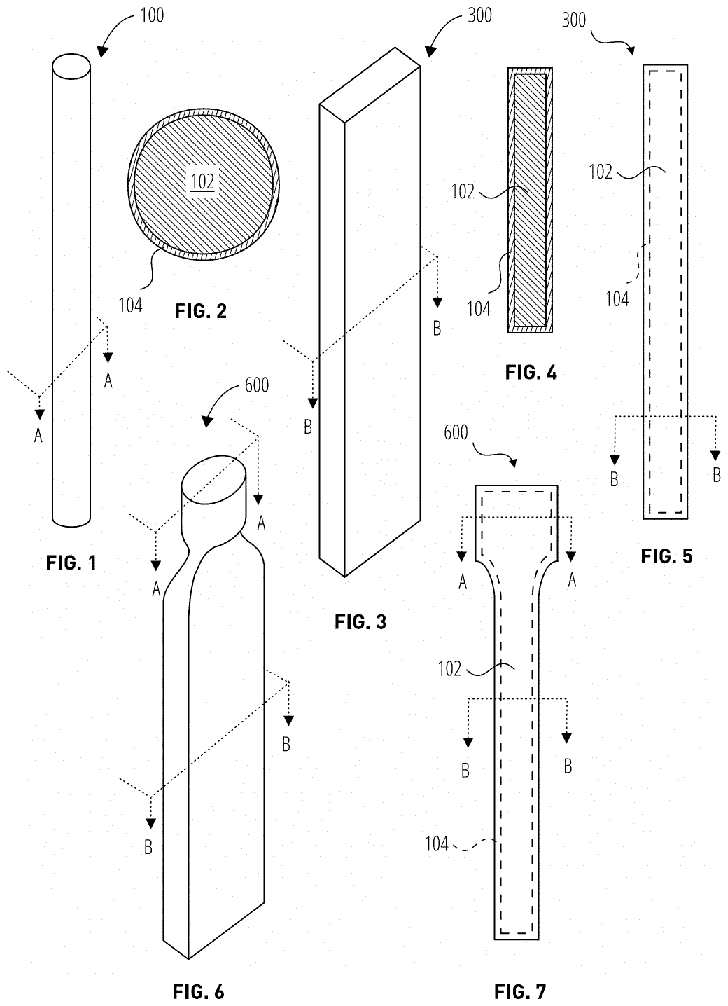

With reference to FIG. 1, in some embodiments a reference electrode 100 may be formed in the shape of a rod (e.g., a wire). With reference to FIG. 2, the reference electrode 100 may include a metal core 102 (e.g., the metal “M” described above) surrounded by a metal-based compound outer layer 104 (e.g., the MₓO_{y}, the MₓC_{y}, or the MₓSi_{y} described above).

With reference to FIG. 3, in additional embodiments, a reference electrode 300 may be formed in the shape of a plate or other planar structure. With reference to FIG. 4, the reference electrode 300 may include the metal core 102 surrounded by the metal-based compound outer layer 104. For example, with reference to FIG. 5, the metal-based compound outer layer 104 may be formed on all vertical sidewalls, on a top surface, and/or on a bottom surface of the reference electrode 300.

With collective reference to FIG. 6 and FIG. 7, in additional embodiments, a reference electrode 600 may be formed in a shape that includes a cylindrical (e.g., rod-like) portion—such as near a top of the structure—as well as a planar (e.g., plate-like) portion—such as near a bottom of the structure. Again, the reference electrode 600 includes the metal core 102 with the metal-based compound outer layer 104, which may wholly enclose the metal core 102.

The disclosure is not limited to the particular configurations or shapes of reference electrodes illustrated in FIG. 1 through FIG. 7. In still other embodiments, the metal core 102 may be more complexly shaped and the metal-based compound outer layer 104 conformally formed on any or all outer surface(s) of the metal core 102.

The thickness of the metal-based compound outer layer 104 (e.g., dimension normal to a surface of the metal core 102 upon which the metal-based compound outer layer 104 is formed) may be tailored according to the molten salt environment in which the reference electrode (e.g., the reference electrode 100 of FIG. 1, the reference electrode 300 of FIG. 3 and FIG. 5, the reference electrode 600 of FIG. 6 and FIG. 7). In some embodiments, the thickness of the metal-based compound outer layer 104 may be less than about 500 μm with the width (e.g., diameter or other lateral dimension) of the metal core 102 being between about 3 mm and about 5 mm.

The metal-based compound outer layer 104 (e.g., the oxide layer (e.g., the metal-oxide layer); the silicide layer (e.g., the metal-silicide layer); or the carbide layer (e.g., the metal-carbide layer)) of the reference electrodes (e.g., the reference electrode 100 of FIG. 1, the reference electrode 300 of FIG. 3 and FIG. 5, the reference electrode 600 of FIG. 6 and FIG. 7) may be formed (e.g., grown) on the metal core 102 by, e.g., a conformal formation, growth, and/or printing (e.g., screen printing, additive manufacturing) processes.

For example, in embodiments in which the metal-based compound outer layer 104 comprises, consists essentially of, or consists of an oxide, the oxide layer may be formed by thermal oxidation (a thermal process), by anodization (an electrochemical process), or a combination thereof. In some embodiments, forming the oxide layer by anodization may grow the oxide with the desired uniformity and durability. After forming the oxide layer on the metal core—whether by thermal or by electrochemical processes—the oxide may be exposed to a reducing/oxidizing atmosphere and/or annealed (e.g., for more than one hour, e.g., more than five hours, e.g., for more than one day, e.g., for several days) to remove residual stresses and to make the oxide layer uniform, in both composition and in thickness, and pore-free (e.g., substantially pore-free) across the surface of the metal core. In some such embodiments, further processing (e.g., post processing) may be carried out to ensure nominal density and stoichiometry of the coating (e.g., the oxide of the metal-based compound outer layer 104).

In embodiments forming the metal-based compound outer layer 104 as an oxide layer by anodization, the anodization forms the MₓO_{y} layer on the M core (e.g., the metal core 102) with adequate stability. For example, a platinum/platinum oxide (Pt/PtO₂) reference electrode—in which the platinum oxide has been formed by anodization of a platinum core (e.g., a nonporous platinum core)—may be useful as a solid-state reference electrode, e.g., by virtue of its near Nernstian behavior, low hysteresis, and rapid response. However, in other embodiments, even an inexpensive metal may prove to be a better, cost-effective alternative.

In some embodiments, a surface oxide layer—as the metal-based compound outer layer 104 of the reference electrode (e.g., the reference electrode 100 of FIG. 1, the reference electrode 300 of FIG. 3 and FIG. 5, the reference electrode 600 of FIG. 6 and FIG. 7)—may be formed by both anodization and a thermally-activated process (e.g., thermal oxidation). During thermal activation (e.g., thermal oxidation), the metal may be kept in a furnace and heated at a slow enough heating rate to a desired temperature (e.g., up to about 500° C.) for several minutes to form a tenacious MₓO_{y} surface layer on the metal (e.g., the metal core 102).

In embodiments in which the metal-based compound outer layer 104 is formed as a carbide, the carbide layer may be formed by first forming an oxide (e.g., MₓO_{y}) on the metal core 102, by any of the techniques described above (e.g., by anodization and/or thermal treatment). The M/MₓO_{y} structure may be heated with graphite powder in hydrogen and/or in a chamber filled with methane up to a temperature of about 1000° C. The heat-treated structure may then be carburized at about 1000° C. for several hours.

In embodiments in which the metal-based compound outer layer 104 is formed as a silicide, the silicide layer may be formed by sizing the metal core 102 to the desired shape and dimensions (e.g., to a desired length, such as if the metal core 102 is a wire) and polishing the metal core 102 with silicon carbide paper (e.g., about 1200 grit silicon carbide paper). The polished metal core 102 may be cleaned in alcohol followed by an ultrasonic cleaning and drying process. The cleaned and dried metal core 102 may, then, be buried in a pack mixture in a crucible (e.g., an alumina crucible). The pack mixture may comprise, consist essentially of, or consist of, e.g., Si, NaF, and Al₂O₃ (e.g., about 12 wt. % Si, about 5 wt. % NaF, and about 83 wt. % Al₂O₃). Then, the buried metal core 102 may be heated to a temperature of about 1300° C. for several hours (e.g., about eight hours) to form the silicide (MₓSi_{y}) metal-based compound outer layer 104 on the metal core 102.

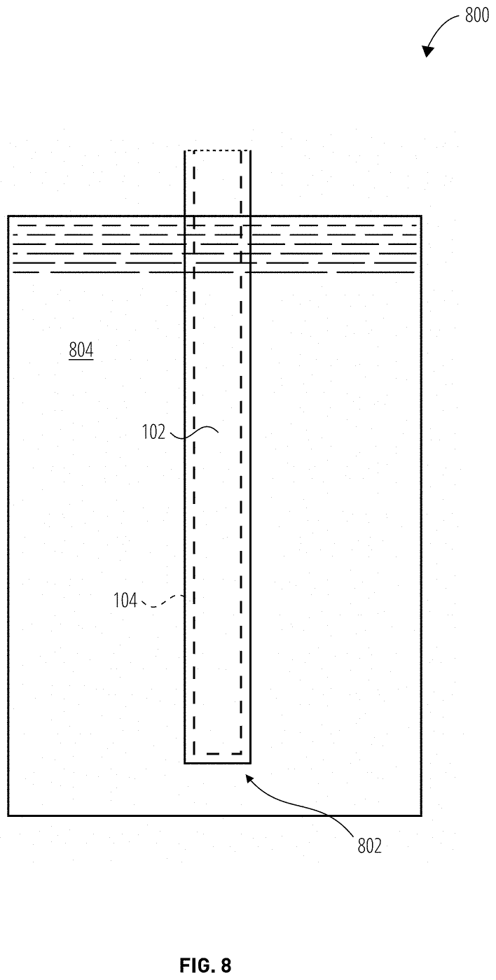

With reference to FIG. 8, illustrated is an electrochemical system 800 in which a reference electrode 802 (e.g., any of the aforementioned reference electrodes, such as the reference electrode 100 of FIG. 1, the reference electrode 300 of FIG. 3 and FIG. 5, the reference electrode 600 of FIG. 6 and FIG. 7) may be used. At least a portion of the reference electrode 802 may be exposed to (e.g., immersed in, submerged in) a molten salt environment 804 (e.g., a bulk electrolyte (e.g., a bulk electrolyte solution) comprising, consisting essentially of, or consisting of a molten salt), which may comprise any one or more of the molten salt electrolytes or other molten salt media described above or below (e.g., a chloride-based molten salt media, a fluoride-based molten salt media, a bromide-based molten salt media, or some combination of any of the foregoing).

The fabricated reference electrode(s) 802 (e.g., the reference electrode 100 of FIG. 1, the reference electrode 300 of FIG. 3 and FIG. 5, the reference electrode 600 of FIG. 6 and FIG. 7) may—depending on the molten salt environment 804 in which it is to be used, such as the temperature of the electrolyte—may be used either directly (e.g., with direct contact between the metal-based compound outer layer 104 and the molten salt environment 804) or indirectly (e.g., with a sheath included around the metal-based compound outer layer 104 and the molten salt environment 804). For example, in embodiments in which the molten salt environment 804 of the electrochemical system 800 is at a relatively-lower temperature (e.g., less than about 500° C.), the reference electrode 802 may be used in the molten salt environment 804 without a sheath. As another example, in embodiments in which the molten salt environment 804 of the electrochemical system 800 is at a relatively-higher temperature (e.g., greater than about 500° C.) and the reference electrode 802 is to be used for a significant period of time (e.g., relatively-longer-term exposure), the reference electrode 802 may be used in the molten salt environment 804 with a suitable inert sheathing material (e.g., formed of and including glass, ceramic, and/or porcelain).

### Examples

A 1 mm nickel wire was selected as a metal core (e.g., the metal core 102) for a reference electrode (e.g., the reference electrode 100 of FIG. 1). A nickel-oxide layer (e.g., the metal-based compound outer layer 104) was formed on the 1 mm nickel wire thermal oxidation. After forming the nickel-oxide layer, the structure was annealed for several days. Metal-metal-oxide reference electrodes were also formed using metal cores of aluminum, tin, titanium, and tungsten.

The annealed metal-metal oxide reference electrodes were examined under an optical microscope to ascertain the growth of the oxide (e.g., metal-oxide) layers. The fabricated electrodes were subsequently immersed in two molten chloride salts (e.g., the molten salt environment 804 of FIG. 8) (LiCl—KCl eutectic and CaCl₂—1 wt. % CaO respectively) for the measurement of open circuit potentials. These measurements were compared with a variety of other reference electrodes, used in chloride melts.

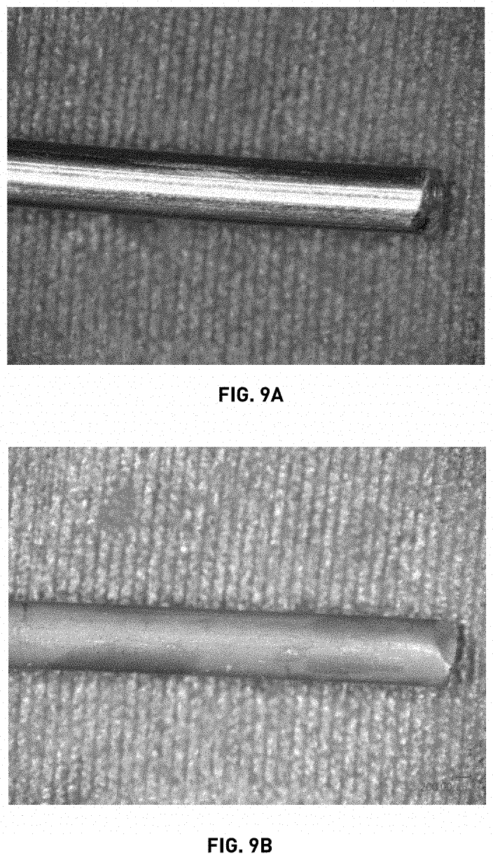

FIG. 9A is a photograph showing the aforementioned 1 mm nickel wire before the oxidation stage. FIG. 9B is a photograph showing the wire after surface oxidation in which the NiO layer was grown by thermal oxidation. More particularly, the thermal oxidation was conducted in static air at 600° C. for a total duration of 8 hours, and then the structure was annealed in argon at 700° C. for about 6 hours. Comparing the two figures, a change in coloration is evident, and this color change indicated the formation of a smooth and adherent surface oxide (e.g., NiO) layer (e.g., as the metal-based compound outer layer 104) on the nickel surface (e.g., the surface of the nickel metal core, as the metal core 102).

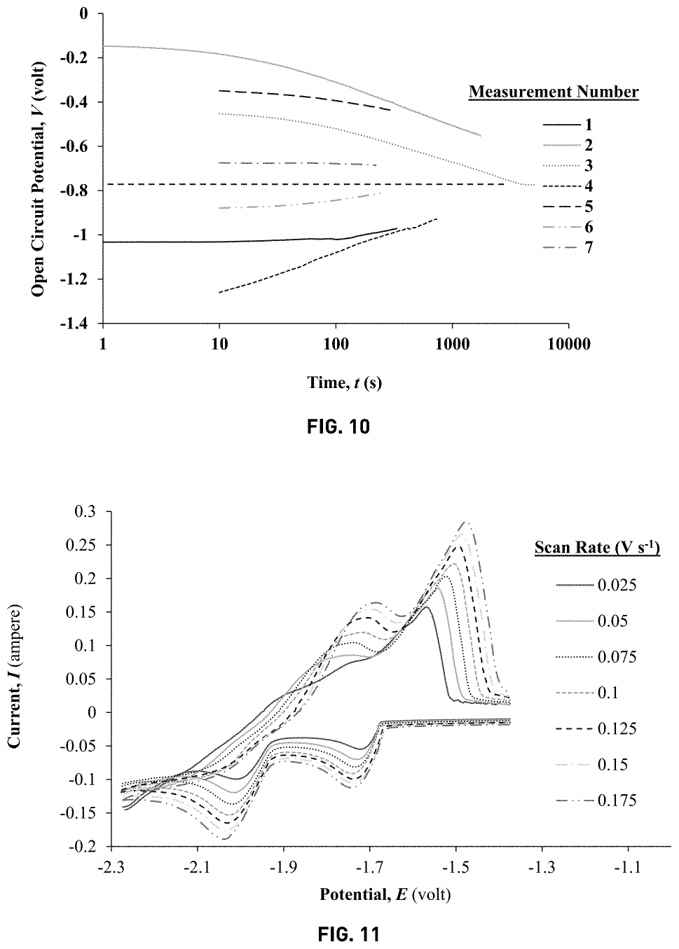

FIG. 10 shows the measurement of the open-circuit potential (OCP) for different duration and/or cycles when the reference electrodes were used in a eutectic LiCl—KCl molten salt electrolyte (e.g., as the molten salt environment 804 of FIG. 8). The measurements indicated fairly stable potentials (with minimum drifts), particularly for measurement numbers at 1, 4, 6, and 7. This shows that the annealing steps can be optimized to obtain fairly stable voltages across the entire measurement duration.

With reference to FIG. 11, the OCP measurements were followed by cyclic voltammetry measurements. More particularly, cyclic voltammetry measurements were taken with the eutectic LiCl—KCl melt containing 2 wt. % YCl₃ and 1 wt. % ScCl₃ (e.g., as the molten salt environment 804 of FIG. 8) at a melt temperature of 500° C. As can be seen from FIG. 11, there was hardly any shift in the anodic and cathodic peaks recorded at different scans, which provides a strong indication in favor of the potential deployment of the new reference electrode. That is, the two sets of cathodic deposition peaks (first for Sc at about −1.7V and second for Y at about −2.05V, respectively, with their corresponding anodic stripping peaks at about −1.6V for Sc and about −1.8V for Y) indicate the robustness in the measured values in that the peak values did not shift at different scanning rates (0.025 Vs⁻¹ to 0.175 Vs⁻¹). Such types of voltammograms have been recorded with conventional reference electrodes, such as Ag/AgCl reference electrodes.

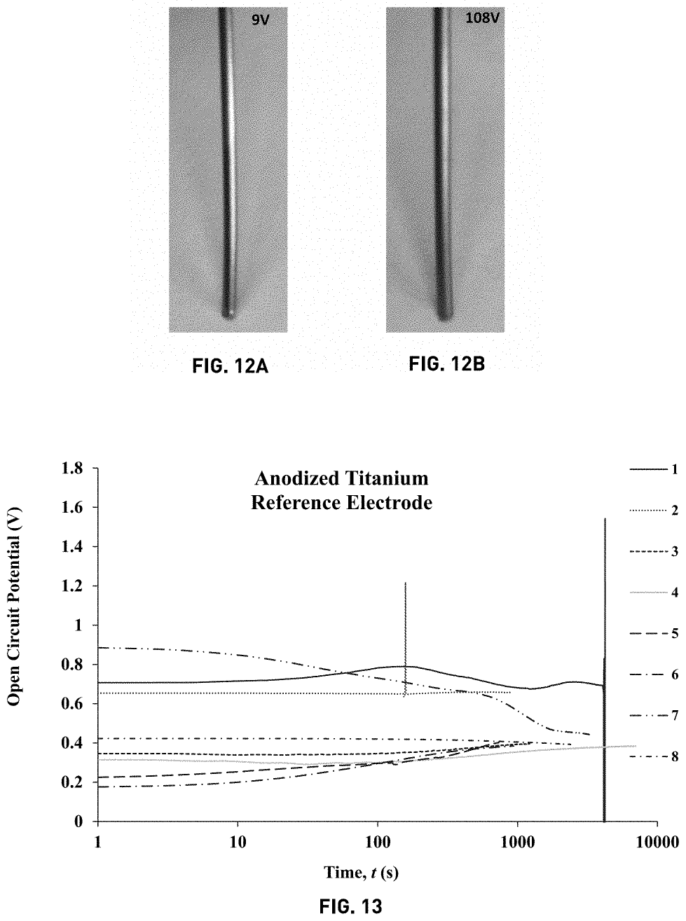

Experiments were also performed to grow oxide layers on titanium and tungsten by an anodization process. FIGS. 12A and 12B show the in situ formed oxide layers on titanium wire (e.g., a metal core—such as the metal core 102 of FIG. 1—consisting of titanium), wherein the titanium oxide layer (e.g., as the metal-based compound outer layer 104 of FIG. 2) was formed by anodization at two different applied voltages: 9V for FIG. 12A and 108V for FIG. 12B.

FIG. 13 shows the OCP measurements taken using the oxidized Ti wire as the reference electrode. The general flat (e.g., horizontal) trend of the plotted curves indicates the tested reference electrode exhibits good stability. As compared to the oxidized nickel (Ni/NiO) reference electrode, the oxidized titanium wire (Ti/TiO₂) reference electrode showed better performance characteristics.

Preliminary measurements with Sn/SnO₂ as a reference electrode and with W/WO₃ as a reference electrode have also shown some initial promise. So, Ti/TiO (i.e., titanium-titanium monoxide) was also evaluated as a potential reference electrode material.

Accordingly, disclosed are reference electrodes and methods of forming reference electrodes that are conducive for use in electrochemical systems that use a molten salt as an electrolyte. The reference electrodes do not require physical contact between a naked (i.e., uncoated) metal core (e.g., wire) and its oxide, silicide, or carbide, which eliminates measurement uncertainties experienced with conventional reference electrodes. The disclosed reference electrodes are effective, even with a wide variety of metals used as the metal of the reference electrodes. The fabricated electrodes can be used in a variety of molten salt media (e.g., a variety of bulk electrolyte solutions), such as chloride molten salt media, fluoride molten salt material, and/or bromide molten salt media (e.g., as the molten salt environment 804 of FIG. 8). And, the reference electrodes of embodiments of the disclosure show promise for successful use in fundamental and applied electrochemical measurements. Moreover, the reference electrodes may be formed by processes that may form (e.g., grow) the oxide (e.g., metal-oxide), the silicide (e.g., metal-silicide), or the carbide (e.g., metal-carbide) layers on the metal cores in such a manner that the oxide, silicide, or carbide layers are uniform over the surface of the metal core and durable enough (e.g., adhering sufficiently to the metal core) to withstand exposure to even the generally-corrosive molten salt media.

While the disclosed apparatus and methods are susceptible to various modifications and alternative forms in implementation thereof, specific embodiments have been shown by way of example in the drawings and have been described in detail herein. However, it should be understood that the present disclosure is not intended to be limited to the particular forms disclosed. Rather, the present disclosure encompasses all modifications, combinations, equivalents, variations, and alternatives falling within the scope of the present disclosure as defined by the following appended claims and their legal equivalents.

What is claimed is:

1. A reference electrode for a molten salt system, the reference electrode comprising:
a metal core; and
a metal-based compound layer along an outer surface of the metal core, the metal-based compound layer comprising an oxide, a silicide, or a carbide of the metal of the metal core,
wherein the metal core and the metal-based compound layer are each solid.

2. The reference electrode of claim 1, wherein the metal comprises at least one of nickel, aluminum, tin, titanium, tungsten, hafnium, zirconium, niobium, iridium, platinum, ruthenium, palladium, rhenium, scandium, or calcium.

3. The reference electrode of claim 1, wherein the metal-based compound layer defines a uniform thickness on the outer surface of the metal core.

4. The reference electrode of claim 1, wherein the reference electrode is wholly solid.

5. The reference electrode of claim 1, wherein the reference electrode does not include a liquid ionic solution.

6. The reference electrode of claim 1, wherein the reference electrode does not include a powder.

7. The reference electrode of claim 1, wherein the metal-based compound defines a thickness along the outer surface of the metal core of less than about 500 μm.

8. A method for fabricating a reference electrode for molten salt systems, the method comprising:
growing a metal-based compound on an outer surface of a metal structure to form an oxide, silicide, or carbide layer uniformly coating the outer surface.

9. The method of claim 8, wherein growing the metal-based compound comprises growing the oxide layer uniformly coating the outer surface.

10. The method of claim 9, further comprising further comprising annealing the oxide layer.

11. The method of claim 9, wherein growing the oxide layer comprises growing the oxide on the outer surface of the metal structure by thermal oxidation.

12. The method of claim 9, wherein growing the oxide layer comprises growing the oxide on the outer surface of the metal by anodization.

13. The method of claim 10, wherein annealing the oxide layer comprises annealing the oxide layer for more than one hour.

14. The method of claim 10, wherein annealing the oxide layer comprises annealing the oxide layer for more than five hours.

15. An electrochemical system, comprising:
an electrolyte comprising a molten salt media; and
a reference electrode comprising a metal-oxide layer, a metal-silicide layer, or a metal-carbide layer on a metal core.

16. The electrochemical system of claim 15, wherein the molten salt media comprises one or more of a chloride-based molten salt media, a fluoride-based molten salt media, or a bromide-based molten salt media.

17. The electrochemical system of claim 16, wherein the molten salt media comprises a eutectic LiCl—KCl molten salt media.

18. The electrochemical system of claim 15, wherein:
the reference electrode comprises the metal-oxide layer,
the metal-oxide layer comprises NiO, and
the metal core comprises Ni.

19. The electrochemical system of claim 15, wherein:
the reference electrode comprises the metal-oxide layer, and
the metal-oxide layer comprises TiO₂ or TiO.
